(19) United States
(12) Patent Application Publication
(10) Pub. No.: US 2023/0050467 A1
(43) Pub. Date: Feb. 16, 2023

(54) GROUND HEIGHT-MAP BASED ELEVATION DE-NOISING

(71) Applicant: GM Cruise Holdings LLC, San Francisco, CA (US)

(72) Inventors: Hariprasad Govardhanam, San Francisco, CA (US); Yue Zhao, Mountain View, CA (US)

(21) Appl. No.: 17/399,599

(22) Filed: Aug. 11, 2021

(51) Int. Cl. G06T 5/00; G06T 5/50; G01S 13/89; G06N 3/02

(52) U.S. Cl. CPC G06T 5/002; G06T 5/50; G01S 13/89; G06N 3/02; G06T 2207/20212; G06T 2207/20084

(57) ABSTRACT

The disclosed technology provides solutions provides solutions for improving sensor data accuracy and in particular, for improving radar data by de-noising radar elevation measurements using a height-map. In some aspects, a process of the disclosed technology can include steps for receiving camera data corresponding with a first location, receiving radar data comprising a plurality of radar points, and processing the radar data to generate height-corrected radar data. In some aspects, the process can further include steps for projecting the height-corrected radar data into an image space to generate radar-image data. Systems and machine-readable media are also provided.

### BACKGROUND

### 1. Technical Field

The disclosed technology provides solutions for improving sensor data accuracy and in particular, for improving radar data by de-noising radar elevation measurements using a height-map.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide a safe and efficient transportation. Such tasks may require the collection and processing of large quantities of data using various sensor types, including but not limited to cameras and/or Light Detection and Ranging (LiDAR) sensors disposed on the AV.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 conceptually illustrates an example of radar elevation de-noising, according to some aspects of the disclosed technology.

FIG. 2A illustrates an example detector system that configured to perform object detection based on de-noised radar data, according to some aspects of the disclosed technology.

FIG. 2B illustrates an example of a two-stage network that is configured to perform object detection based on de-noised radar data, according to some aspects of the disclosed technology.

FIG. 3 illustrates a block diagram of a process for performing elevation de-noising, according to some aspects of the disclosed technology.

FIG. 4 illustrates an example system environment that can be used to facilitate AV dispatch and operations, according to some aspects of the disclosed technology.

FIG. 5 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Radio Detection and Ranging (radar) sensors collect data about an environment by receiving reflected electromagnetic waves that can be used to determine certain properties about the reflecting objects. Radar sensors can be used to measure location parameters for various objects, including an angle of azimuth, a range, and an elevation. In common deployments, elevation measurements can indicate an object location along a vertical axis, e.g., with respect to the ground. However, depending on the desired orientation of the radar's antennae, elevation measurements can be used to generate location measurements along other axial orientations or directions.

In some radar deployments, elevation measurements can be noisy, as compared to measurements for azimuth and range. By way of example, in typical radar deployments, elevation errors can commonly be in the range of ±20 meters of an object's actual location. Due to the measurement error attendant in radar elevation measurements, radar signals have limited use for applications in which highly accurate localization information is needed, such as in the deployment of autonomous vehicles (AVs).

Aspects of the disclosed technology address the foregoing limitations by providing solutions for improving the accuracy of radar signals by reducing the amount of error (noise) in radar elevation measurements. In some aspects, de-noising of radar data can be performed using a priori information about the location of one or more objects in an environment, such as using ground-height information (also: ground map information) for environments in which object locations are measured. As discussed in further detail below, de-noised radar data can be used to improve the quality/accuracy of detection models, such as machine-learning based object location detectors and/or semantic classifiers.

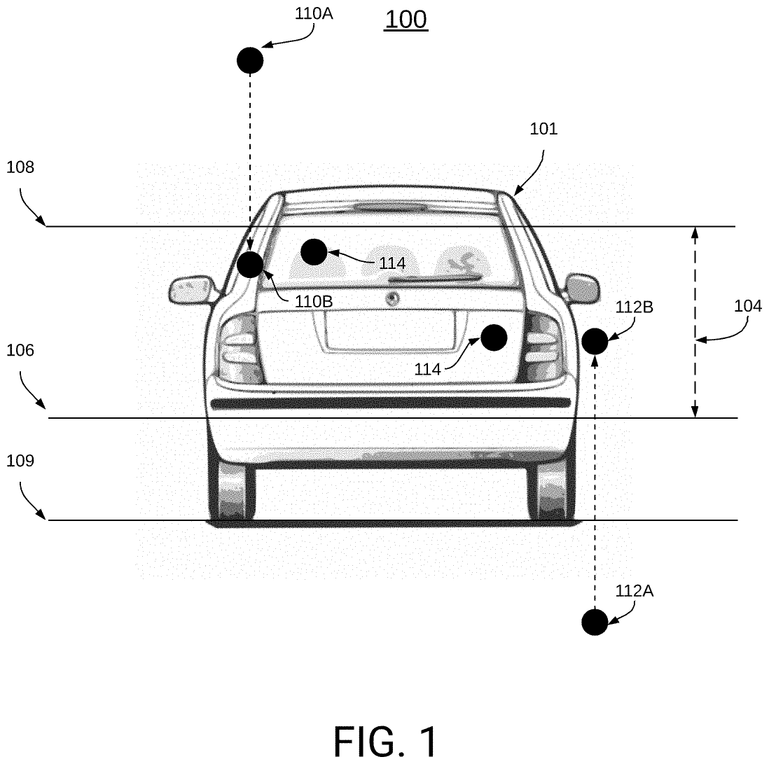

FIG. 1 conceptually illustrates an example environment 100 for which radar data can be collected. The collected radar data can include multiple individual radar point measurements, e.g., radar points (110, 112, 114) that represent electromagnetic waves reflected from various objects (e.g., vehicle 101) in the environment 100. As illustrated in the example of FIG. 1, some radar data points, such as points 110A and 112A can be outside of a pre-determined height range 104, that is represented by a lower height boundary 106, and an upper height boundary 108. In some implementations, lower height boundary 106 can define a pre-determined elevation (height) about a ground level 109, such as 0.50 meters. Similarly, upper height boundary 108 can define a pre-determined elevation about the ground level 109, such as 1.50 meters. It is understood that the lower height boundary 106 and the upper height boundary 108 may be defined using different distances from the ground level 109, without departing from the scope of the disclosed technology.

In practice, one or more various radar points collected from environment 100 may be selected for de-noising, for example, by adjusting elevation parameters associated with those points. In some examples, those radar points falling outside of height range 104 may be selected. For example, radar points that are below lower height boundary 106 (e.g., point 112A), and/or above upper height boundary 108 (e.g., point 110A) may be selected for de-noising adjustment. In such approaches, an elevation parameter associated with the selected radar points can be modified/adjusted so that the points fall within the height range 104. In the example illustrated by FIG. 1, point 110A is adjusted to an elevation represented by point 110B, whereas point 112A is adjusted to an elevation represented by point 112B.

In the example of FIG. 1, the lower/upper height boundaries (106, 108) can be defined with respect to a known, or predefined, reference point or reference elevation, such as ground level 109. By way of example, ground level 109 may be defined using a prior map data, such as LiDAR data or other elevation data that is contained in a high-definition autonomous vehicle (AV) map. However, it is understood that other elevation reference points may be used, without departing from the scope of the disclosed technology. By way of example, known elevations for other objects in the location associated with environment 100 may be used to define the height range 104, without departing from the scope of the disclosed technology.

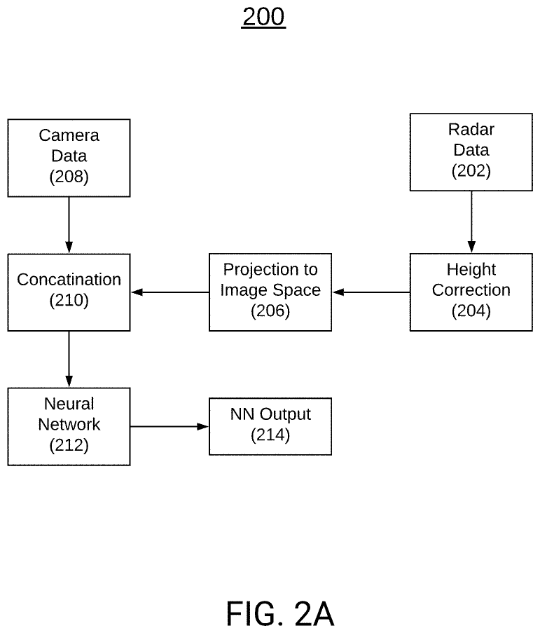

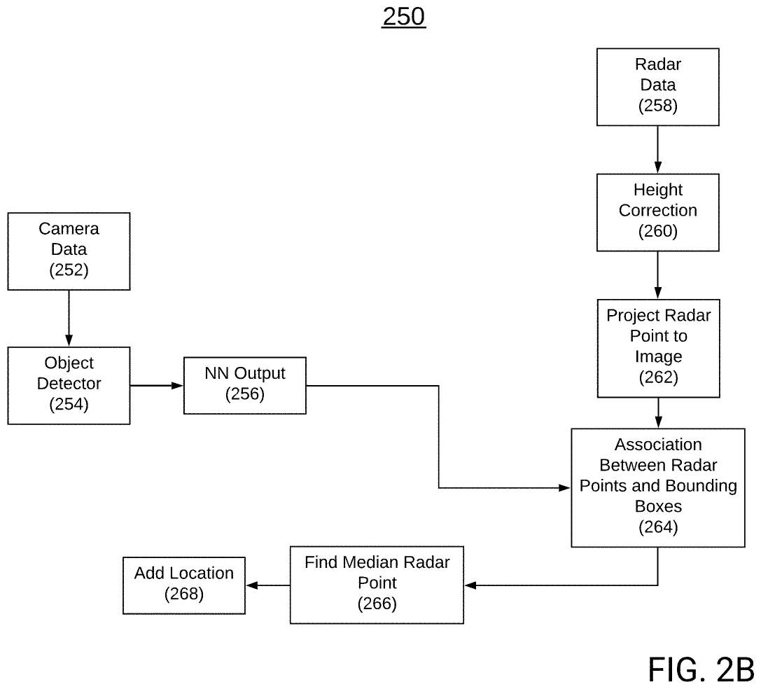

FIG. 2A illustrates an example detector system 200 that is configured to perform object detection based on de-noised radar data. System 200 includes a radar collection process 202 in which radar data is received/aggregated, e.g., from one or more radar sensors. In practice, the radar sensors may be configured to collect environmental data from the environs around an operating AV, however, other types of radar deployments are contemplated, without departing from the scope of the disclosed technology. After the radar data has been aggregated/received (block 202), height correction (elevation de-noising) can be performed on the radar data, for example, using a process similar to that described with respect to FIG. 1, above. Subsequently, the de-nosed radar data can be projected into an image space (block 206), e.g., to generate radar-image data, so that it can be combined with received camera data (208), e.g., in a concatenation process (210). In some implementations, the concatenated camera data (210) can include color values in addition to one or more radar measurements. By way of example, the concatenated camera data can include Red, Green, and Blue (RGB) color dimensions, as well as a depth (D) (or range) value, i.e., the concatenated radar data can be defined using an RGBD space.

In some aspects, the concatenated camera data (210) can be provided as an input to detector network, such as a neural network (212) that is configured to perform detection/classification for a variety of features. By way of example, neural network (212) can be configured to produce outputs (214) that can be used to localize one or more objects represented in the camera data/radar data, such as by indicating a location and/or pose (yaw) of the one or more objects. In such aspects, location and or pose may be represented by one or more bounding boxes used to enclose or identify the object locations and/or object centroid locations.

In other implementations, neural network 212 may be configured to classify one or more objects represented by the radar data 202/camera data 208 using semantic labels. For example, neural network 212 may be configured to identify map features, e.g., road signs, drive-able areas, walkable areas, parking spots, and/or bike stalls, etc.

FIG. 2B illustrates an example of a two-stage network 250 that is configured to perform object detection based on de-noised radar data. Two stage network 250 includes a camera data collection process (252), in which camera data is received/aggregated, e.g., from one or more camera systems, for example that correspond with one or more AVs. The camera data is then provided to a detector (object detector 254), to perform object detection for one or more image objects represented in the camera data (252). In some implementations, the detector (254) can be configured to generate two-dimensional (2D) and/or three-dimensional (3D) bounding boxes around detected image objects, e.g., as a neural network output (NN output 256). In some aspects, the output (256) may include classifications, such as semantic classifications (semantic labels) that represent map features or other types of semantic labels.

The bounding boxes generated by the detector (254) can be associated with radar points (264), for example, that are represented in a received radar-image (block 262). Similar to the elevation de-noising aspects discussed above with respect to FIG. 2A, the radar-image data can be generated from radar data (258) that has been processed to perform height-correction or elevation de-noising (block 260), and projected into an image space, e.g., as radar-image data (block 262).

In some approaches, further processing can be performed to identify boundaries between different bounding boxes that are associated with different radar point clusters. For example, statistical heuristics, such as identifying a median radar point (block 266) can be used to disaggregated various object bounding boxes along a depth field. Subsequently location information may be added/associated with the variously identified bounding boxes, and their corresponding objects (block 268).

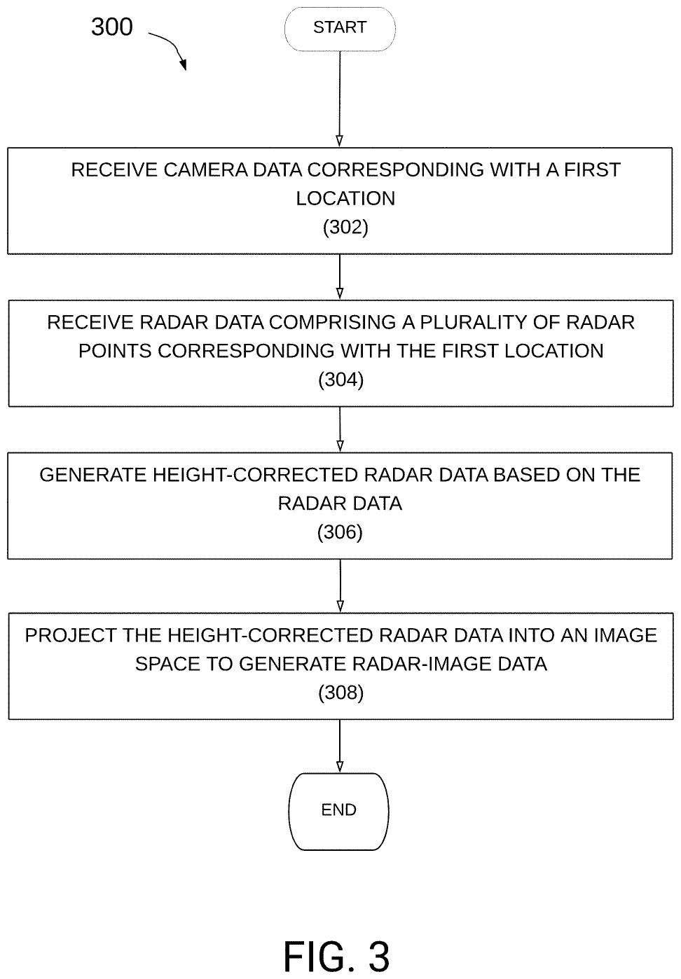

FIG. 3 illustrates a block diagram of an example process 300 for performing elevation de-noising. At block 302, process 300 includes receiving camera data corresponding with a first location. In some aspects, the camera data can include image/video collected by one or more cameras, for example, that are associated with more or more vehicles, such as one or more AVs.

At block 304, the process 300 includes receiving radar data comprising a plurality of radar points corresponding with the first location. In some approaches, the camera data (block 302) and radar data (block 304) may be captured concurrently, e.g., by camera and radar sensors associated with a common vehicle, such as an AV. In other approaches, the camera and radar data may be collected at different times, and by different sensors, such as by sensors associated with different vehicles (AVs).

At block 306, the process 300 includes processing the radar data to generate height-corrected radar data. As discussed above with respect to FIGS. 1 and 2A-2B, height correction (or elevation de-noising) can be performed to adjust the elevation parameter for selected radar points so that those points fall within a predetermined height range. By way of example, radar points below a particular height threshold (e.g., 0.50 meters), or above a particular height threshold (e.g., 1.5 meters), may be selected for adjustment. The identification of upper/lower thresholds, and therefore the selection of any given radar point for elevation adjustment, can be based on ground-height map data. For example, ground height maps (also: ground maps) comprising camera data, LiDAR data, etc., can be used to determine the elevation of the ground below (or around) a given object. Using a priori ground-height data (e.g., ground map information), elevation de-noising can be performed to bring adjust all radar points to an elevation that is within a given pre-determined range.

At block 308, the process 300 includes projecting the height-corrected radar data into an image space to generate radar-image data. Radar-to-image projections (e.g., to produce radar-image data), can be performed in order to merge (or align) radar point data with captured image data. In this manner, camera points (e.g., RGB pixels) can be associated with radar data (e.g., depth) at corresponding locations in a 2D image space.

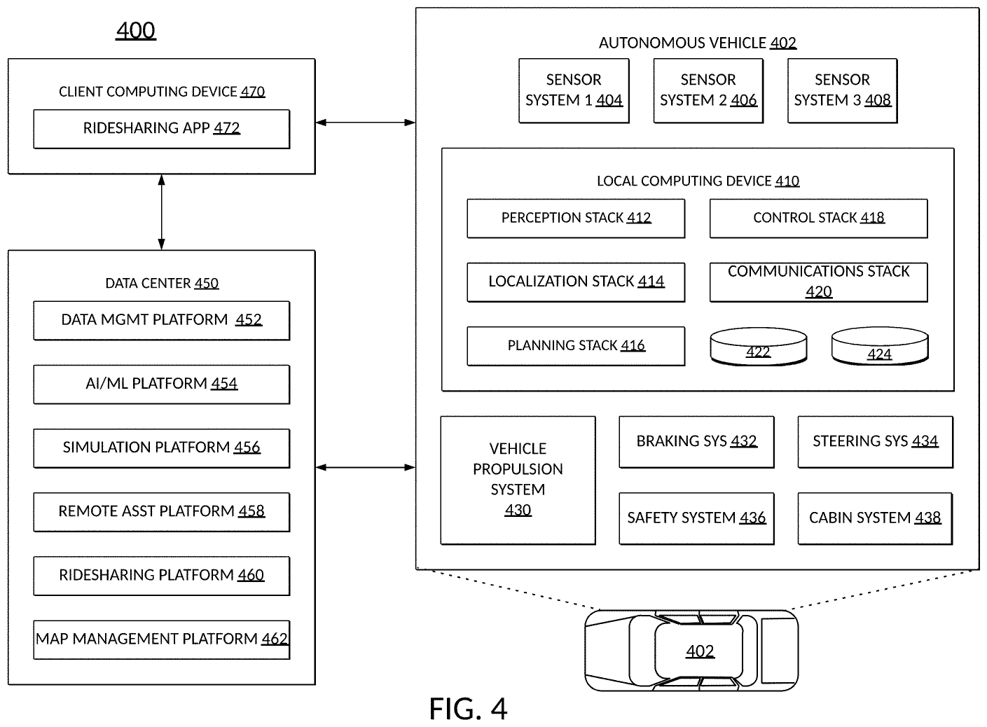

Turning now to FIG. 4 illustrates an example of an AV management system 500. One of ordinary skill in the art will understand that, for the AV management system 400 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 400 includes an AV 402, a data center 450, and a client computing device 470. The AV 402, the data center 450, and the client computing device 470 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 402 can navigate about roadways without a human driver based on sensor signals generated by multiple sensor systems 404, 406, and 408. The sensor systems 404-408 can include different types of sensors and can be arranged about the AV 402. For instance, the sensor systems 404-408 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 404 can be a camera system, the sensor system 406 can be a LIDAR system, and the sensor system 408 can be a RADAR system. Other embodiments may include any other number and type of sensors.

AV 402 can also include several mechanical systems that can be used to maneuver or operate AV 402. For instance, the mechanical systems can include vehicle propulsion system 430, braking system 432, steering system 434, safety system 436, and cabin system 438, among other systems. Vehicle propulsion system 430 can include an electric motor, an internal combustion engine, or both. The braking system 432 can include an engine brake, brake pads, actuators, and/or any other suitable componentry configured to assist in decelerating AV 402. The steering system 434 can include suitable componentry configured to control the direction of movement of the AV 402 during navigation. Safety system 436 can include lights and signal indicators, a parking brake, airbags, and so forth. The cabin system 438 can include cabin temperature control systems, in-cabin entertainment systems, and so forth. In some embodiments, the AV 402 may not include human driver actuators (e.g., steering wheel, handbrake, foot brake pedal, foot accelerator pedal, turn signal lever, window wipers, etc.) for controlling the AV 402. Instead, the cabin system 438 can include one or more client interfaces (e.g., Graphical User Interfaces (GUIs), Voice User Interfaces (VUIs), etc.) for controlling certain aspects of the mechanical systems 430-438.

AV 402 can additionally include a local computing device 410 that is in communication with the sensor systems 404-408, the mechanical systems 430-438, the data center 450, and the client computing device 470, among other systems. The local computing device 410 can include one or more processors and memory, including instructions that can be executed by the one or more processors. The instructions can make up one or more software stacks or components responsible for controlling the AV 402; communicating with the data center 450, the client computing device 470, and other systems; receiving inputs from riders, passengers, and other entities within the AV's environment; logging metrics collected by the sensor systems 404-408; and so forth. In this example, the local computing device 410 includes a perception stack 412, a mapping and localization stack 414, a planning stack 416, a control stack 418, a communications stack 420, an HD geospatial database 422, and an AV operational database 424, among other stacks and systems.

Perception stack 412 can enable the AV 402 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 404-408, the mapping and localization stack 414, the HD geospatial database 422, other components of the AV, and other data sources (e.g., the data center 450, the client computing device 470, third-party data sources, etc.). The perception stack 412 can detect and classify objects and determine their current and predicted locations, speeds, directions, and the like. In addition, the perception stack 412 can determine the free space around the AV 402 (e.g., to maintain a safe distance from other objects, change lanes, park the AV, etc.). The perception stack 412 can also identify environmental uncertainties, such as where to look for moving objects, flag areas that may be obscured or blocked from view, and so forth.

Mapping and localization stack 414 can determine the AV's position and orientation (pose) using different methods from multiple systems (e.g., GPS, IMUs, cameras, LIDAR, RADAR, ultrasonic sensors, the HD geospatial database 422, etc.). For example, in some embodiments, the AV 402 can compare sensor data captured in real-time by the sensor systems 404-408 to data in the HD geospatial database 422 to determine its precise (e.g., accurate to the order of a few centimeters or less) position and orientation. The AV 402 can focus its search based on sensor data from one or more first sensor systems (e.g., GPS) by matching sensor data from one or more second sensor systems (e.g., LIDAR). If the mapping and localization information from one system is unavailable, the AV 402 can use mapping and localization information from a redundant system and/or from remote data sources.

The planning stack 416 can determine how to maneuver or operate the AV 402 safely and efficiently in its environment. For example, the planning stack 416 can receive the location, speed, and direction of the AV 402, geospatial data, data regarding objects sharing the road with the AV 402 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 402 from one point to another. The planning stack 416 can determine multiple sets of one or more mechanical operations that the AV 402 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 416 can select from multiple backup plans to carry out. For example, while preparing to change lanes to turn right at an intersection, another vehicle may aggressively cut into the destination lane, making the lane change unsafe. The planning stack 416 could have already determined an alternative plan for such an event, and upon its occurrence, help to direct the AV 402 to go around the block instead of blocking a current lane while waiting for an opening to change lanes.

The control stack 418 can manage the operation of the vehicle propulsion system 430, the braking system 432, the steering system 434, the safety system 436, and the cabin system 438. The control stack 418 can receive sensor signals from the sensor systems 404-408 as well as communicate with other stacks or components of the local computing device 410 or a remote system (e.g., the data center 450) to effectuate operation of the AV 402. For example, the control stack 418 can implement the final path or actions from the multiple paths or actions provided by the planning stack 416. This can involve turning the routes and decisions from the planning stack 416 into commands for the actuators that control the AV's steering, throttle, brake, and drive unit.

The communication stack 420 can transmit and receive signals between the various stacks and other components of the AV 402 and between the AV 402, the data center 450, the client computing device 470, and other remote systems. The communication stack 420 can enable the local computing device 410 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 420 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 422 can store HD maps and related data of the streets upon which the AV 402 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal U-turn lanes; permissive or protected only right turn lanes; etc.). The traffic controls lane can include geospatial information of traffic signal lights, traffic signs, and other road objects and related attributes.

The AV operational database 424 can store raw AV data generated by the sensor systems 404-408 and other components of the AV 402 and/or data received by the AV 402 from remote systems (e.g., the data center 450, the client computing device 470, etc.). In some embodiments, the raw AV data can include HD LIDAR point cloud data, image data, RADAR data, GPS data, and other sensor data that the data center 450 can use for creating or updating AV geospatial data.

The data center 450 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 450 can include one or more computing devices remote to the local computing device 410 for managing a fleet of AVs and AV-related services. For example, in addition to managing the AV 402, the data center 450 may also support a ridesharing service, a delivery service, a remote/roadside assistance service, street services (e.g., street mapping, street patrol, street cleaning, street metering, parking reservation, etc.), and the like.

The data center 450 can send and receive various signals to and from the AV 402 and client computing device 470. These signals can include sensor data captured by the sensor systems 404-408, roadside assistance requests, software updates, ridesharing pick-up and drop-off instructions, and so forth. In this example, the data center 450 includes a data management platform 452, an Artificial Intelligence/Machine Learning (AI/ML) platform 454, a simulation platform 456, a remote assistance platform 458, a ridesharing platform 460, and map management system platform 462, among other systems.

Data management platform 452 can be a “big data” system capable of receiving and transmitting data at high velocities (e.g., near real-time or real-time), processing a large variety of data, and storing large volumes of data (e.g., terabytes, petabytes, or more of data). The varieties of data can include data having different structure (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 450 can access data stored by the data management platform 452 to provide their respective services.

The AI/ML platform 454 can provide the infrastructure for training and evaluating machine learning algorithms for operating the AV 402, the simulation platform 456, the remote assistance platform 458, the ridesharing platform 460, the map management system platform 462, and other platforms and systems. Using the AI/ML platform 454, data scientists can prepare data sets from the data management platform 452; select, design, and train machine learning models; evaluate, refine, and deploy the models; maintain, monitor, and retrain the models; and so on.

The simulation platform 456 can enable testing and validation of the algorithms, machine learning models, neural networks, and other development efforts for the AV 402, the remote assistance platform 458, the ridesharing platform 460, the map management system platform 462, and other platforms and systems. The simulation platform 456 can replicate a variety of driving environments and/or reproduce real-world scenarios from data captured by the AV 402, including rendering geospatial information and road infrastructure (e.g., streets, lanes, crosswalks, traffic lights, stop signs, etc.) obtained from the map management system platform 462; modeling the behavior of other vehicles, bicycles, pedestrians, and other dynamic elements; simulating inclement weather conditions, different traffic scenarios; and so on.

The remote assistance platform 458 can generate and transmit instructions regarding the operation of the AV 402. For example, in response to an output of the AI/ML platform 454 or other system of the data center 450, the remote assistance platform 458 can prepare instructions for one or more stacks or other components of the AV 402.

The ridesharing platform 460 can interact with a customer of a ridesharing service via a ridesharing application 472 executing on the client computing device 470. The client computing device 470 can be any type of computing system, including a server, desktop computer, laptop, tablet, smartphone, smart wearable device (e.g., smart watch, smart eyeglasses or other Head-Mounted Display (HMD), smart ear pods or other smart in-ear, on-ear, or over-ear device, etc.), gaming system, or other general purpose computing device for accessing the ridesharing application 472. The client computing device 470 can be a customer's mobile computing device or a computing device integrated with the AV 402 (e.g., the local computing device 410). The ridesharing platform 460 can receive requests to be picked up or dropped off from the ridesharing application 472 and dispatch the AV 402 for the trip.

Map management system platform 462 can provide a set of tools for the manipulation and management of geographic and spatial (geospatial) and related attribute data. The data management platform 452 can receive LIDAR point cloud data, image data (e.g., still image, video, etc.), RADAR data, GPS data, and other sensor data (e.g., raw data) from one or more AVs 402, UAVs, satellites, third-party mapping services, and other sources of geospatially referenced data. The raw data can be processed, and map management system platform 462 can render base representations (e.g., tiles (2D), bounding volumes (3D), etc.) of the AV geospatial data to enable users to view, query, label, edit, and otherwise interact with the data. Map management system platform 462 can manage workflows and tasks for operating on the AV geospatial data. Map management system platform 462 can control access to the AV geospatial data, including granting or limiting access to the AV geospatial data based on user-based, role-based, group-based, task-based, and other attribute-based access control mechanisms. Map management system platform 462 can provide version control for the AV geospatial data, such as to track specific changes that (human or machine) map editors have made to the data and to revert changes when necessary. Map management system platform 462 can administer release management of the AV geospatial data, including distributing suitable iterations of the data to different users, computing devices, AVs, and other consumers of HD maps. Map management system platform 462 can provide analytics regarding the AV geospatial data and related data, such as to generate insights relating to the throughput and quality of mapping tasks.

In some embodiments, the map viewing services of map management system platform 462 can be modularized and deployed as part of one or more of the platforms and systems of the data center 450. For example, the AI/ML platform 454 may incorporate the map viewing services for visualizing the effectiveness of various object detection or object classification models, the simulation platform 456 may incorporate the map viewing services for recreating and visualizing certain driving scenarios, the remote assistance platform 458 may incorporate the map viewing services for replaying traffic incidents to facilitate and coordinate aid, the ridesharing platform 460 may incorporate the map viewing services into the client application 472 to enable passengers to view the AV 402 in transit en route to a pick-up or drop-off location, and so on.

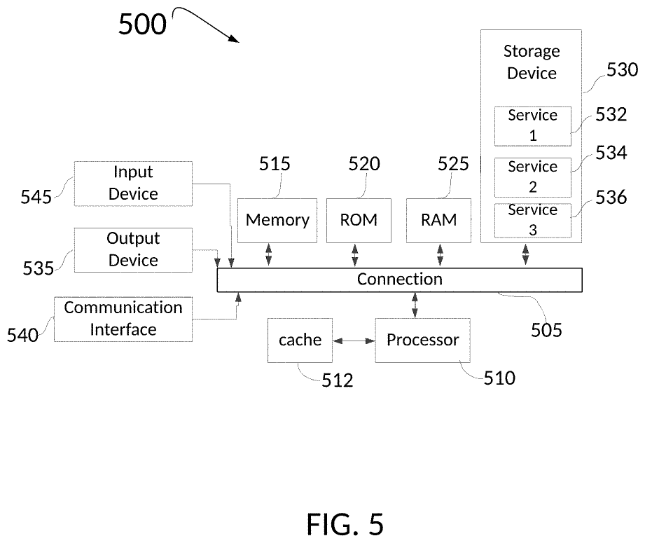

FIG. 5 illustrates an example processor-based system with which some aspects of the subject technology can be implemented. For example, processor-based system 500 can be any computing device making up internal computing system 510, remote computing system 550, a passenger device executing the rideshare app 570, internal computing device 530, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random-access memory (RAM) 525 to processor 510. Computing system 500 can include a cache of high-speed memory 512 connected directly with, in close proximity to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communication interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

Storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. An apparatus, comprising:
at least one memory; and
at least one processor coupled to the at least one memory, the at least one processor configured to:
receive camera data corresponding with a first location;
receive radar data comprising a plurality of radar points, wherein the plurality of radar points correspond with the first location;
process the radar data to generate height-corrected radar data; and
project the height-corrected radar data into an image space to generate radar-image data.

2. The apparatus of claim 1, wherein the at least one processor is further configured to:
generate concatenated camera data based on the camera data and the radar-image data.

3. The apparatus of claim 2, wherein the at least one processor is further configured to:
provide the concatenated camera data to a detection model, and
wherein the detection model comprises a neural-network.

4. The apparatus of claim 3, wherein the neural-network is configured to generate at least one bounding box to indicate a location of at least one object represented in the concatenated camera data.

5. The apparatus of claim 1, wherein process the radar data to generate height-corrected radar data, further comprises:
select one or more radar points from among the plurality of radar data points based on a predetermined elevation range; and
adjust an elevation parameter associated with the one or more radar points based on ground map information corresponding with the first location.

6. The apparatus of claim 5, wherein the predetermined elevation range is between 0.50 to 1.5 meters above a ground elevation indicated by the ground map information.

7. The apparatus of claim 5, wherein the ground map information comprises Light Detection and Ranging (LiDAR) data, camera data, or a combination thereof.

8. A computer-implemented method for de-noising radar data, comprising:
receiving camera data corresponding with a first location;
receiving radar data comprising a plurality of radar points, wherein the plurality of radar points correspond with the first location;
processing the radar data to generate height-corrected radar data; and
projecting the height-corrected radar data into an image space to generate radar-image data.

9. The method of claim 8, further comprising:
generating concatenated camera data based on the camera data and the radar-image data.

10. The method of claim 9, further comprising:
providing the concatenated camera data to a detection model, and
wherein the detection model comprises a neural-network.

11. The method of claim 10, wherein the neural-network is configured to generate at least one bounding box to indicate a location of at least one object represented in the concatenated camera data.

12. The method of claim 8, wherein processing the radar data to generate height-corrected radar data, further comprises:
selecting one or more radar points from among the plurality of radar data points based on a predetermined elevation range; and
adjust an elevation parameter associated with the one or more radar points based on ground map information corresponding with the first location.

13. The method of claim 12, wherein the predetermined elevation range is between 0.50 to 1.5 meters above a ground elevation indicated by the ground map information.

14. The method of claim 12, wherein the ground map information comprises Light Detection and Ranging (LiDAR) data, camera data, or a combination thereof.

15. A non-transitory computer-readable storage medium comprising at least one instruction for causing a computer or processor to:
receive camera data corresponding with a first location;
receive radar data comprising a plurality of radar points, wherein the plurality of radar points correspond with the first location;
process the radar data to generate height-corrected radar data; and
project the height-corrected radar data into an image space to generate radar-image data.

16. The non-transitory computer-readable storage medium of claim 15, wherein the at least one instruction is further configured to cause the computer or processor to:
generate concatenated camera data based on the camera data and the radar-image data.

17. The non-transitory computer-readable storage medium of claim 16, wherein the at least one instruction is further configured to cause the computer or processor to:
provide the concatenated camera data to a detection model, and
wherein the detection model comprises a neural-network.

18. The non-transitory computer-readable storage medium of claim 17, wherein the neural-network is configured to generate at least one bounding box to indicate a location of at least one object represented in the concatenated camera data.

19. The non-transitory computer-readable storage medium of claim 15, wherein process the radar data to generate height-corrected radar data, further comprises:
select one or more radar points from among the plurality of radar data points based on a predetermined elevation range; and
adjust an elevation parameter associated with the one or more radar points based on ground map information corresponding with the first location.

20. The non-transitory computer-readable storage medium of claim 19, wherein the predetermined elevation range is between 0.50 to 1.5 meters above a ground elevation indicated by the ground map information.
